(19) United States
(12) Patent Application Publication
(10) Pub. No.: US 2017/0009955 A1
(43) Pub. Date: Jan. 12, 2017

(54) LIGHTING DEVICE

(71) Applicant: KOWA COMPANY, LTD., Nagoya-shi, Aichi (JP)

(72) Inventor: Suguru Mukumoto, Komaki-shi, Aichi (JP)

(21) Appl. No.: 15/114,331

(22) PCT Filed: Jan. 29, 2015
(86) PCT No.: PCT/JP2015/052442

§ 371 Date: Jul. 26, 2016

(30) Foreign Application Priority Data
Jan. 30, 2014 (JP) 2014-015283

(51) Int. Cl. F21V 3/02; F21V 17/16; F21V 7/00; F21V 23/04; F21S 8/04; F21V 13/08; F21V 19/00; F21K 9/272; F21V 9/08

(52) U.S. Cl. CPC F21V 3/02; F21K 9/272; F21V 17/166; F21V 7/0008; F21V 9/08; F21S 8/04; F21V 13/08; F21V 19/003; F21V 23/04; F21Y 2115/10

(57) ABSTRACT

LEDs (21) that emit illumination light and a cover unit (30) that houses the LEDs are provided. The cover unit is composed of a front cover part (31) that transmits, diffuses and reflects the illumination light from the LEDs and a rear cover part (32) that reflects the illumination light reflected at the front cover part again toward the front cover part. The front cover part and the rear cover part are integrally molded without a gap and the loss of light fluxes is therefore eliminated. Moreover, the uniformity of luminance distribution of the light-emitting surface is improved to solve the problem in that the side surfaces of the lighting device and the attaching surface (ceiling surface) are dark.

### TECHNICAL FIELD

The present invention relates to a lighting device in which one or more LEDs are used as light sources, and in more detail, relates to a lighting device that is composed of an equipment main body and a cover unit and disposed at a ceiling surface.

### BACKGROUND ART

Lighting equipment attached to a ceiling surface and having one or more LEDs as light sources is mainly composed of an equipment main body to be a base and a cover unit to be a light-emitting part, and the cover unit houses an LED mounting substrate. Patent Literature 1 below discloses an LED lighting device that is composed of an LED unit (corresponding to the cover unit) on which LED chips are mounted and a mount (corresponding to the equipment main body) which holds the LED unit.

LEDs as the light sources have strong directionality. Therefore, in a directly mounted-type lighting equipment that is disposed at a ceiling surface, the amount of light that is emitted from the LEDs and reaches side surfaces of the lighting equipment and the ceiling surface is less than that from a fluorescent lamp, which may be problematic in that dark areas occur.

Patent Literature 2 discloses lighting equipment in which the cover part is modified such that a part of light emitted from the light sources illuminates the side surfaces of the equipment main body and the ceiling surface.

In order to enhance the uniformity of luminance distribution of the light-emitting surface, improve the energy efficiency, and prevent dark areas from occurring at the ceiling surface, a member having transmitting diffusivity and a member having high reflectivity may have to be combined. Specifically, a member having a property of transmitting/diffusing light may be used as a part (front cover part) that forms an appearance of the cover unit, while a member having high reflectivity may be used as a part (rear cover part) that is not visible as the appearance of the cover unit to which the LED mounting substrate is fixed.

A predefined space is provided between the front cover part and the rear cover part. Light emitted from the light sources into the predefined space has transmitting diffusivity (and some reflecting diffusivity) at the front cover part and is diffusively reflected at the rear cover part, thereby to pass through complex light paths in the cover unit, so that a light-emitting surface having highly uniform luminance distribution may be finally obtained. The lighting device is thus modified such that the energy efficiency is improved.

### PRIOR ART LITERATURE

### Patent Literature

[Patent Literature 1] WO2010/095710

[Patent Literature 1] JP2011-258384A

### SUMMARY OF THE INVENTION

### Problems to be Solved by the Invention

The member having transmitting diffusivity and the member having high reflectivity as the above are assembled as separate members, and therefore the assembling consumes time. In addition, the conventional highly-reflective material may possibly delaminate due to the aging degradation because it is fixed using a pressure sensitive adhesive tape.

Another problem is that a boundary formed between the part having transmitting diffusivity and the part having high reflectivity may cause a risk of the loss of light fluxes due to light leakage, etc. to reduce the uniformity of luminance distribution of the light-emitting surface. Moreover, the LED mounting substrate generates a considerable amount of heat, which may cause a strain in the LED mounting substrate and its peripheral members to result in problems including the occurrence of cracks in the soldering part and the reduction in the light emitting efficiency of the lighting device as a whole.

The present invention has been made to solve such problems and an object of the present invention is to provide a lighting device that allows the light-emitting surface to have highly uniform luminance distribution and improves the energy efficiency as well as is less likely to cause a strain of members due to heat generated in the mounting substrate and sustainable for prolonged use.

### Means for Solving the Problems

The present invention provides a lighting device comprising: an illumination light source that emits illumination light; a cover unit that houses the illumination light source; and a main body for attaching.

The cover unit comprises: a front cover part that transmits, diffuses and reflects the illumination light from the illumination light source; and a rear cover part that reflects and diffuses the illumination light reflected partially at the front cover part again toward the front cover part.

The lighting device is characterized in that the cover unit is configured such that the front cover part and the rear cover part are integrally molded.

In the present invention, a substrate holder may be provided to fix a mounting substrate on which the illumination light source is mounted, and the substrate holder may be engaged with the rear cover part so as to be fixed to the rear cover part. In the present invention, the mounting substrate may be pressed against the rear cover part by a biasing force of the substrate holder so as to be fixed to the rear cover part.

In the present invention, the front cover part may contain a yellow pigment.

### Advantageous Effect of the Invention

According to the present invention, the cover unit is configured such that the front cover part which transmits and diffuses the illumination light from the illumination light source and the rear cover part, which reflects the illumination light reflected partially at the front cover part again toward the front cover part are integrally molded. This allows easy assembly and can prevent both the parts from delaminating due to aging degradation because the attaching means such as a pressure sensitive adhesive tape and an adhesive as in the prior art is not used for adhesion between the front cover part and the rear cover part. Moreover, the front cover part and the rear cover part are integrally molded so that a boundary is not formed between the part having transmitting diffusivity and the part having high reflectivity. Therefore, the loss of light fluxes is eliminated and the uniformity of luminance distribution of the light-emitting surface is improved to solve the problem in that the side surfaces of the lighting device and the attaching surface (ceiling surface) are dark.

According to an embodiment of the present invention, the entire end sides of the mounting substrate may be fixed by the rear cover part and the substrate holder. Therefore, an effect can be obtained that the heat dissipation effect of the substrate holder suppresses the occurrence of a strain due to heat generated in the mounting substrate and its peripheral members.

The front cover part can be colored yellow, for example, by containing a yellow pigment, and therefore light fluxes of wavelengths equal to or shorter than 500 nm can be cut from the emission spectrum of a white light source. Thus, a lighting device is obtained which can be effectively used in a clean room of a semiconductor factory where a photosensitive material of high sensitivity is used.

### BRIEF DESCRIPTION OF DRAWINGS

FIG. 1 is a partial perspective view illustrating the structure of a lighting device according to the present invention.

FIG. 2 is a cross-sectional view of the lighting device according to the present invention.

FIG. 3 is a cross-sectional view illustrating a state in which a cover unit of the lighting device according to the present invention is pivotally moved to be opened with respect to an equipment main body.

FIG. 4 is a schematic cross-sectional view illustrating the spreading of light rays in the lighting device according to the present invention.

FIG. 5a is a view for explaining effects of the present invention.

FIG. 5b is a view for explaining effects in a conventional structure.

FIG. 6 is a perspective view illustrating another example of the structure of a lighting device according to the present invention.

FIG. 7 is a cross-sectional view of the lighting device illustrated in FIG. 6.

FIG. 8 is a cross-sectional view illustrating still another example of the structure of a lighting device according to the present invention.

### EMBODIMENTS FOR CARRYING OUT THE INVENTION

Hereinafter, examples of the present invention will be described in detail with reference to the appended drawings.

### Example 1

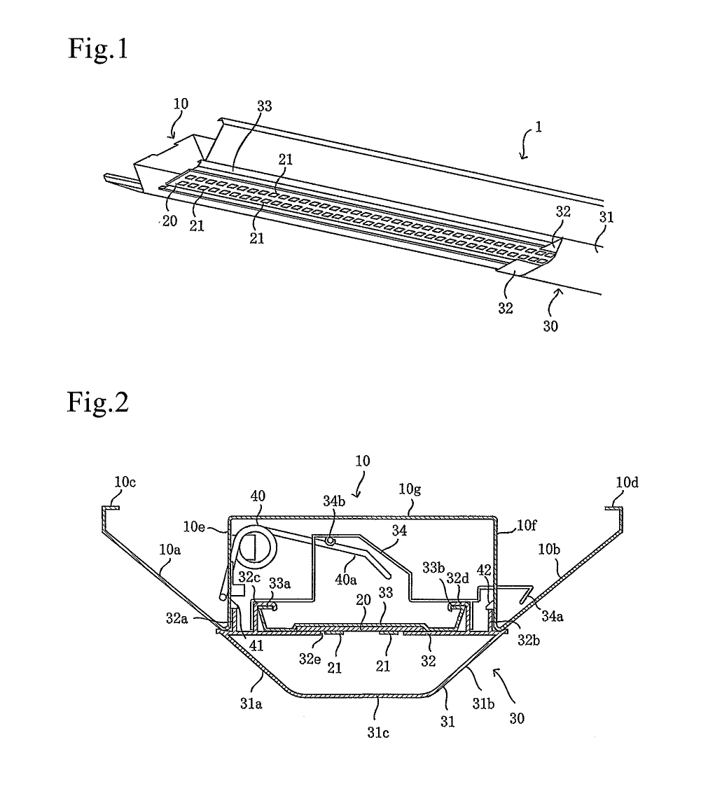

FIG. 1 is a perspective view illustrating the structure of a primary part of a lighting device according to the present example, and FIG. 2 is a cross-sectional view thereof. Lighting device 1 comprises: an equipment main body 10 that has an attaching structure to a ceiling surface; and a cover unit 30 that houses amounting substrate 20 on which a plurality of LEDs 21 used as light sources is mounted.

In FIG. 1, the cover unit 30 is illustrated such that the left-hand portion is removed to show the mounting substrate 20.

The equipment main body 10 is a member that extends in the longitudinal direction and has a channel-shaped cross section in which right and left portions in the width direction of the equipment main body 10 form inclined parts 10a and 10b and vertical parts 10e and 10f and the ceiling side is a horizontal part 10g. The equipment main body 10 is produced using a single metal plate. The equipment main body 10 can be fixed to a ceiling by using wood screws that pass through the holes opened in the horizontal part 10g or by screwing nuts (not illustrated) to anchor bolts (not illustrated) that hang from the ceiling. The vertical parts 10e and 10f and horizontal part 10g of the equipment main body 10 form a space, which accommodates a power supply (not illustrated), an engaging member 34, and a coil spring 40. The power supply supplies electric power to the mounting substrate 20 on which the LEDs 21 are mounted. The LEDs 21 are mounted on the mounting substrate so as to be arranged in two rows at regular intervals in the longitudinal direction.

The cover unit 30 is a member that comprises a front cover part 31 having transmitting diffusivity and some reflecting diffusivity and a rear cover part 32 having high reflectivity and diffusivity. This member is integrally molded using plastic and extends in the longitudinal direction substantially in the same manner as that of the equipment main body 10. Both end portions in the width direction of the front cover part 31 are inclined to form inclined parts 31a and 31b and the middle portion of the front cover part 31 is formed as a flat part 31c. The inclined parts 31a and 31b of the front cover part 31 have the same inclined angle as that of the inclined parts 10a and 10b of the equipment main body 10. Therefore, when the cover unit 30 is attached to the equipment main body 10, the inclined parts 31a and 31b of the front cover part 31 are successively aligned at the same inclined angle with the inclined parts 10a and 10b of the equipment main body 10, so that the cross-sectional shape of the lighting device as a whole is an inverted trapezoidal shape.

Since both end portions of the front cover part 31 are inclined, a space having an inverted trapezoidal shape is also formed between the front cover part 31 and the rear cover part 32. As will be described later, the directional illumination light emitted from the LEDs repeats reflecting and diffusing in the space except a part of light fluxes that transmits through from the space.

The rear cover part 32 of the cover unit 30 extends in the width direction parallel to the flat part 31c of the front cover part 31. Both end portions of the rear cover part 32 protrudes to form protruding parts 32a and 32b, inside which hook parts 32c and 32d are formed, respectively. An elongate opening 32e is formed in the middle of the rear cover part 32. The illumination light sources 21 arranged in two rows on the mounting substrate 20 are exposed through the elongate opening 32e.

The mounting substrate 20 is pressed against and fixed to the rear cover part 32 by the biasing force of a metallic substrate holder 33 of which both end portions 33a and 33b are folded to engage with the hook parts 32c and 32d, respectively, of the rear cover part 32.

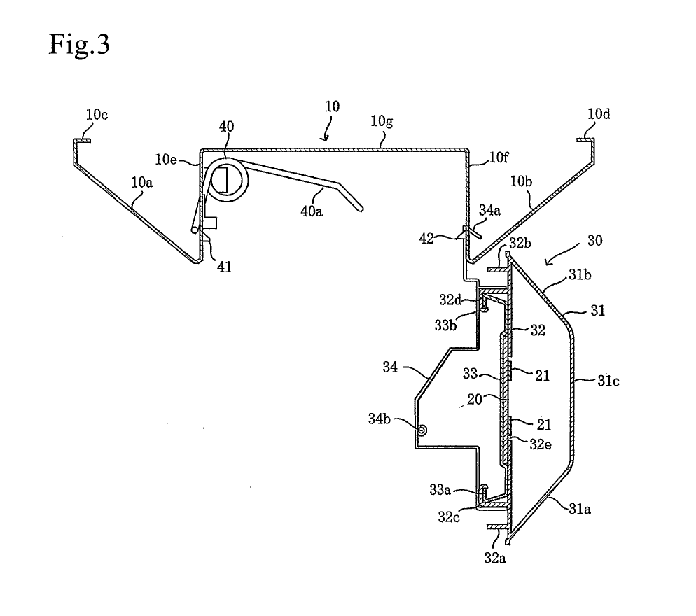

The lighting device 1 is provided with a metallic engaging member 34 for engaging the cover unit 30 with the equipment main body 10. The engaging member 34 has a hook part 34a that engages with an elongate hole formed in the vertical part 10f of the equipment main body 10 (this elongate hole is not visible in FIG. 2, FIG. 3, etc. in relation to the cross-sectional position). The engaging member 34 is fixed to the hook parts 32c and 32d of the rear cover part 32, such as by screws. An engaging part 34b is formed at the middle portion of the engaging member 34. This engaging part 34b is engaged with one end portion 40a of a coil spring 40 that is fixed to the equipment main body 10.

The coil spring 40 is wound such that the one end portion 40a is biased upward when viewed in FIG. 2. Therefore, when the engaging member 34 engages with the one end portion 40a of the coil spring 40 from the above, the engaging member 34 and the rear cover part 32 which is fixed to the engaging member 34 are lifted up, so that the cover unit 30 as a whole moves upward. This motion continues until the protruding parts 32a and 32b of the rear cover part 32 come into contact with stoppers 41 and 42 that are attached to both sides of the equipment main body 10. This allows the cover unit 30 to be attached to the equipment main body 10 in a fixed manner.

On the other hand, when the cover unit 30 is pulled down against the biasing force of the coil spring 40, the cover unit 30 is pivotally moved, as illustrated in FIG. 3, from the horizontal position to the vertical position around an elongate hole provided in the vertical part 10f of the equipment main body 10.

The front cover part 31 and rear cover part 32 of the cover unit 30 may be molded using known double molding (two-color molding) in which the cover unit 30 is formed such that the front cover part 31 as the primary side is molded and the rear cover part 32 as the secondary side is then molded integrally with the front cover part of the primary side in the same mold (in an alternative example, the primary side may be the rear cover part and the secondary side may be the front cover part). Polycarbonate (or acrylic) may be used, for example, as the front cover part 31 and the rear cover part 32. The front cover part 31 has transmitting diffusivity and some reflecting diffusivity and the rear cover part 32 has high reflectivity and diffusivity.

The front cover part 31 can be molded with some pigment mixed therein and can thus be colored, for example, yellow. When a yellow pigment is contained in the front cover part 31 in this manner, light fluxes of wavelengths equal to or shorter than 500 nm can be cut from the emission spectrum of a white light source. Therefore, a lighting device of a so-called “yellow lamp” can be obtained. Such a lighting device does not expose a photosensitive material of high sensitivity and is suitable for a clean room of a semiconductor factory where such a photosensitive material of high sensitivity is used.

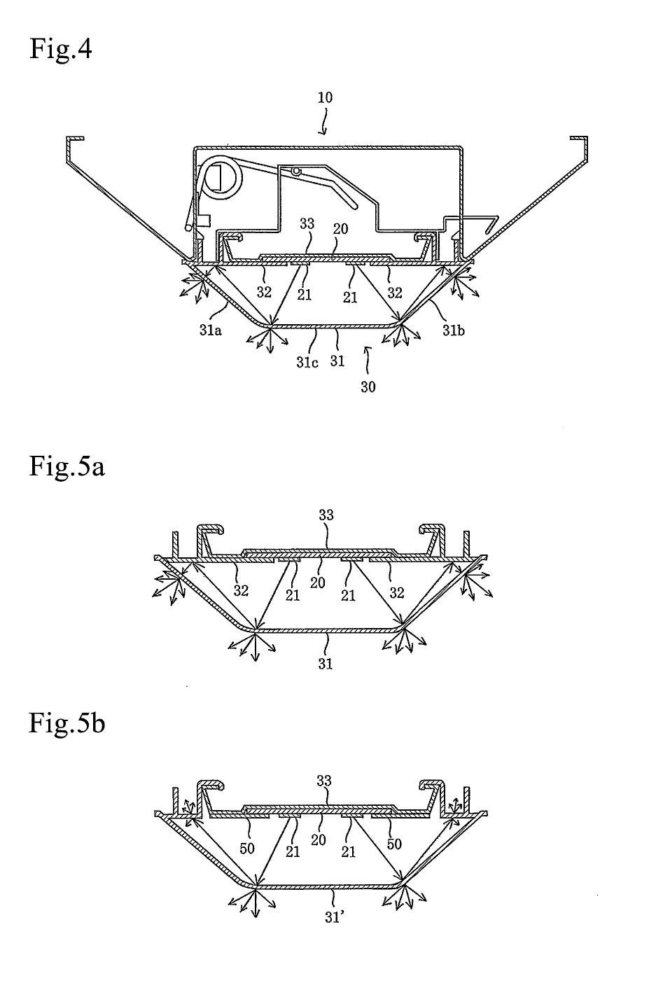

FIG. 4 schematically illustrates paths of illumination light when the LEDs 21 are lighting. The illumination light directed toward the inclined parts 31a and 31b or flat part 31c of the front cover part 31 mainly transmits through the front cover part 31 to illuminate an object. Since the front cover part 31 also has some reflecting diffusivity, a part of the illumination light is directed toward the rear cover part 32 and reflected and diffused at the rear cover part 32 to be directed again toward the front cover part 31. Thus, the illumination light repeats reflecting and diffusing except a part of light fluxes that transmits through from the space formed between the front cover part 31 and the rear cover part 32, and a light-emitting surface of which the whole surface is uniform can be obtained.

FIG. 5a illustrates paths of the illumination light when the LEDs 21 are lighting in a state in which the equipment main body 10, the engaging member 34, the coil spring 40 and other components are removed. The front cover part 31 and the rear cover part 32 are provided as an integrally-molded member, but have different optical characteristics. Accordingly, these parts 31 and 32 are illustrated with separate cross sections of differently-angled hatch lines in FIG. 5a in order to indicate that they have different optical characteristics.

FIG. 5b illustrates a conventional example in which the cover unit consists only of a cover 31′ that has transmitting diffusivity. In this case, a boundary is formed between the cover 31′ and a highly reflective material 50 that is attached to the substrate holder 33 and the mounting substrate 20, such as by a double sided pressure sensitive adhesive tape and an adhesive, and the boundary leads to a problem in that there is a risk of loss of light fluxes due to light leakage from the cover unit, and the like, to deteriorate the uniformity of luminance distribution of the light-emitting surface. There is also a risk of aging degradation because the highly reflective material 50 is attached, such as using a double sided pressure sensitive adhesive tape and an adhesive.

In contrast, in the lighting device according to the present example, the cover unit is configured such that the front cover part which transmits and diffuses the illumination light from the illumination light source and the rear cover part which reflects the illumination light reflected at the front cover part toward the front cover part are integrally molded. This allows easy assembly and can prevent both the parts from delaminating due to aging degradation because the attaching means such as a pressure sensitive adhesive tape and an adhesive as in the prior art is not used. Moreover, the front cover part and the rear cover part are integrally molded without a gap to eliminate the loss of light fluxes, and the uniformity of luminance distribution of the light-emitting surface is improved to solve the problem in that the side surfaces of the lighting device and the attaching surface (ceiling surface) are dark.

According to the present example, the hook parts 32c and 32d provided at the rear cover part 32 of the cover unit 30 are engaged with and fixed to the folded end portions 33a and 33b of the substrate holder 33 thereby to bias and fix the mounting substrate 20 to the rear cover part 32, and therefore the light does not leak. In addition, the heat dissipation property is improved to enhance the energy efficiency of the LED elements as the illumination light sources 21 because the substrate holder 33 is made of metal, and an effect can be obtained that the lifetime of the illumination light sources 21 is prolonged.

### Example 2

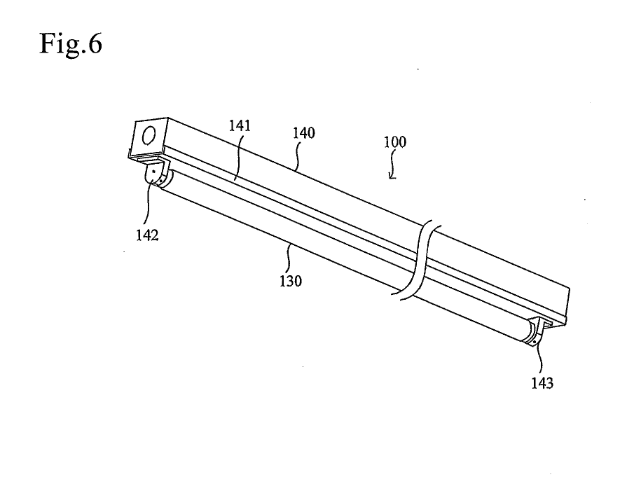

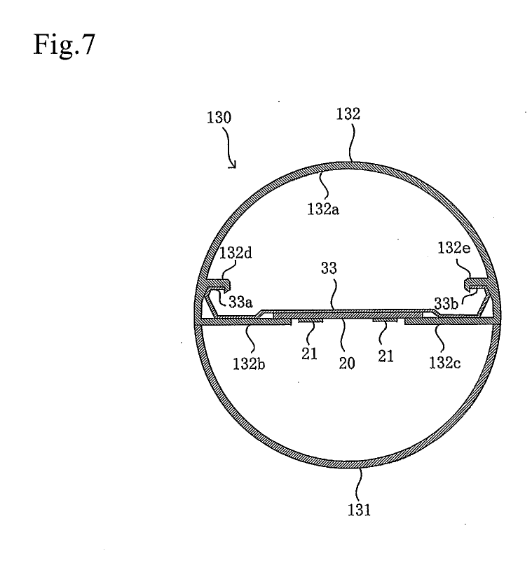

FIG. 6 and FIG. 7 are a perspective view and a cross-sectional view, respectively, of the structure of a so-called straight tube-type lighting device 100 which has a similar shape to that of a conventional fluorescent lamp. Similar members to those of Example 1 are denoted by the same reference numerals and the detailed explanation will be omitted.

Lighting device 100 comprises: a cover unit 130 that houses LEDs 21; and an equipment main body 140 to which the cover unit 130 is attached. The equipment main body 140 is made of metal and has a cuboidal shape. The equipment main body 140 can be fixed to a ceiling by using wood screws or by screwing nuts (not illustrated) to anchor bolts (not illustrated) that hang from the ceiling, in a similar manner to that for the equipment main body 10 of Example 1. Sockets 142 and 143 are fixed to both end portions of a metallic lid 141 that is attached to the equipment main body 140.

Similar to a conventional fluorescent lamp, the cover unit 130 has a cylindrical straight tube-type appearance and the cross-sectional shape is a circular shape. Both ends of the cover unit 130 are each provided with two electrode pins (not illustrated). The electrode pins are inserted into the sockets 142 and 143 thereby to allow the cover unit 130 to be attached to the equipment main body 140. The motion of rotating the cover unit 130 establishes the connection between the electrode pins and power source terminals to light the LEDs 21 located inside.

Lower half of the cover unit 130 constitutes a front cover part 131 that corresponds to the front cover part 31 of Example 1, and upper half of the cover unit 130 constitutes a rear cover part 132 that corresponds to the rear cover part 32 of Example 1. The rear cover part 132 has a semicircular part 132a, horizontal parts 132b and 132c that extend in the horizontal direction at both right and left lower end portions of the semicircular part 132a, and hook parts 132d and 132e with which both end portions 33a and 33b of the metallic substrate holder 33 are engaged. The mounting substrate 20 is pressed against the horizontal parts 132b and 132c of the rear cover part 132 by the biasing force of the substrate holder 33 so that the entire end sides of the mounting substrate 20 are fixed between the substrate holder 33 and the horizontal parts 132b and 132c of the rear cover part 132.

The front cover part 131 has transmitting diffusivity and some reflecting diffusivity similar to the front cover part 31 of Example 1, and the rear cover part 132 has reflectivity and diffusivity similar to the rear cover part 32 of Example 1. These cover parts 131 and 132 are integrally molded by known double molding (two-color molding) using, for example, polycarbonate (or acrylic). This allows the illumination light from the LEDs 21 to transmit, diffuse, and reflect in accordance with the characteristics as illustrated in FIG. 4. As in Example 1, the front cover part 131 may contain a yellow pigment to achieve the characteristics as those of a “yellow lamp” used in a clean room of a semiconductor factory or the like.

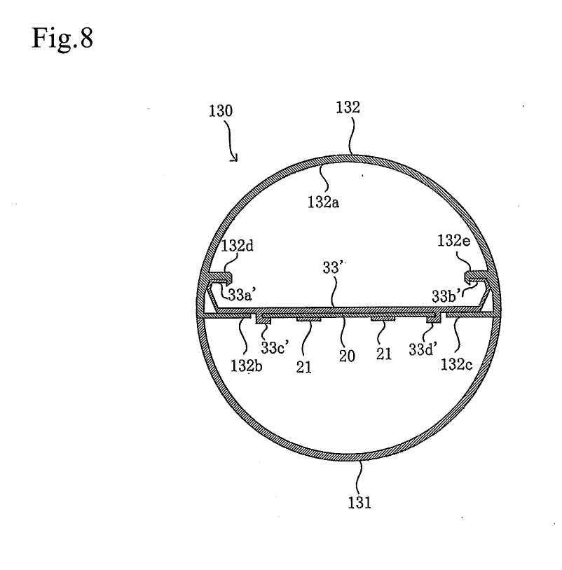

The front cover part 131 and the rear cover part 132 are integrally formed by double molding, but have different optical characteristics. Accordingly, the front cover part 131 and the rear cover part 132 are illustrated with separate cross sections of differently-angled hatch lines in FIG. 7 (and FIG. 8 below), as in FIG. 5a, in order to indicate that they have different optical characteristics.

In the example illustrated in FIG. 7, both end portions of the mounting substrate 20 are pressed against and fixed to the horizontal parts 132b and 132c of the rear cover part 132 by the biasing force of the substrate holder 33. In an alternative example, as illustrated in FIG. 8, a substrate holder 33′ may be formed with attaching parts 33c′ and 33d′ in which attaching recesses are formed below the substrate holder 33′, and the both end portions of the mounting substrate 20 may be attached to these attaching parts 33c′ and 33d′ so that the mounting substrate 20 is fixed to the substrate holder 33′. The both end portions 33a′ and 33b′ of the substrate holder 33′ are engaged with or caught by hook parts 132d and 132e of the rear cover part 132 as in FIG. 7, and a similar effect to that of the example illustrated in FIG. 7 can be obtained.

### DESCRIPTION OF REFERENCE NUMERALS

1 Lighting device

10 Equipment main body

20 Mounting substrate

21 LEDs

30 Cover unit

31 Front cover part

32 Rear cover part

33, 33′ Substrate holder

34 Engaging member

40 Coil spring

50 Highly reflective material

100 Lighting device

130 Cover unit

131 Front cover part

132 Rear cover part

140 Equipment main body

1. A lighting device comprising: an illumination light source that emits illumination light; a cover unit that houses the illumination light source; and a main body for attaching,
the cover unit comprising: a front cover part that transmits, diffuses and reflects the illumination light from the illumination light source; and a rear cover part that reflects and diffuses the illumination light reflected partially at the front cover part again toward the front cover part,
the cover unit being configured such that the front cover part and the rear cover part are integrally molded.

2. The lighting device as recited in claim 1, further comprising a substrate holder that fixes a mounting substrate on which the illumination light source is mounted.

3. The lighting device as recited in claim 2, wherein the substrate holder is engaged with the rear cover part so as to be fixed to the rear cover part.

4. The lighting device as recited in claim 2, wherein the mounting substrate is pressed against the rear cover part by a biasing force of the substrate holder so as to be fixed to the rear cover part.

5. The lighting device as recited in claim 1, wherein the front cover part contains a yellow pigment.
